(19) United States
(12) Patent Application Publication
(10) Pub. No.: US 2011/0013320 A1
(43) Pub. Date: Jan. 20, 2011

(54) HARD DISK DRIVE HAVING SLIDER LIMITER

(75) Inventor: Jae-suk Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/835,862

(22) Filed: Jul. 14, 2010

(30) Foreign Application Priority Data
Jul. 16, 2009 (KR) 2009-64942

(51) Int. Cl. G11B 5/54

(52) U.S. Cl. 360/250; G9B/5.181

(57) ABSTRACT

A hard disk drive (HDD) including a slider limiter. The HDD includes a spindle motor installed to a base member; at least one disk mounted to the spindle motor to be rotated by the spindle motor; an actuator moving a read/write head to a desired position on the at least one disk; and a ramp that is installed outside the at least one disk to park the read/write head when the at least one disk stops rotating. A slider limiter that is disposed between the flexures facing each other in order to limit vertical fluctuation of the slider is formed on the ramp. A step portion or a hollow space is formed in a portion of the slider limiter facing the slider, and a side-tab is protruded from both sides of the flexure to face the slider limiter on both sides of the hollow space.

### CROSS-REFERENCE TO RELATED APPLICATIONS

This application claims priority under 35 U.S.C. §119(a) of Korean Patent Application No. 10-2009-0064942, filed on Jul. 16, 2009, in the Korean Intellectual Property Office, the disclosure of which is incorporated herein in its entirety by reference.

### BACKGROUND

1. Field of the Invention

The inventive concept relates to a hard disk drive, and more particularly, to a hard disk drive including a slider limiter that prevents collision between sliders and deformation of a suspension assembly due to intense shocks.

2. Description of the Related Art

A hard disk drive (HDD), which is one of information storage devices, writes data to a disk or a reads data from the disk using a read/write head. In the HDD, a read/write head is floated at a predetermined height from a recording surface of the disk while the disk is rotated, and is moved to a desire position by an actuator, to perform its function.

When the HDD is not in use, that is, when the disk is not rotating, the read/write head is parked off of the recording surface of the disk to prevent the read/write head from colliding against the recording surface of the disk. The parking system of the read/write head includes a contact start stop (CSS) method and a ramp loading method. In the CSS method, a parking zone where data is not recorded is provided in an inner circumferential side of the disk and the read/write head is parked in the parking zone by contacting the parking zone. In the ramp loading method, a ramp is installed outside the disk and the read/write head is parked on the ramp.

However, in the CSS method, in the state in which the read/write head is parked in the parking zone that is provided in the inner circumferential side of the disk, when an external shock is applied to the HDD while the HDD has stopped operating, that is, when the disk is not rotating, the disk and the read/write head vibrate due to the shock and collide against each other. Accordingly, the read/write head can be damaged, and the performance of the read/write head can deteriorate.

In the ramp loading method, the read/write head is parked on the ramp when the HDD is not in use, and thus the read/write head can be prevented from being damaged due to collision between the disk and the read/write head.

FIG. 1 is a perspective view illustrating a conventional head parking ramp, and FIGS. 2A and 2B are side views illustrating a read/write head parked on the conventional head parking ramp illustrated in FIG. 1.

Referring to FIGS. 1 and 2A, an HDD includes at least one disk, here disks 11 and 12, and an actuator 20 for moving sliders 25 including read/write heads for reading or writing data from or to a predetermined position on the disks 11 and 12.

The actuator 20 includes a swing arm 21, a suspension assembly 22 that is mounted to an end portion of the swing arm 21 and supports the slider 25 to which the read/write head is mounted, so that the slider 25 is elastically biased toward a surface of the disk 11 or 12, and a voice coil motor (VCM) (not shown) for rotating the swing arm 21. The suspension assembly 22 includes a load beam 23 coupled to a side end portion of the swing arm 21 and a flexure 24 attached to the load beam 23. The slider 25 is attached to the flexure 24 to be supported by the flexure 24.

When the HDD is not in use, that is, when rotation of the disks 11 and 12 is stopped, the read/write heads are parked off recording surfaces of the disks 11 and 12 to prevent collision of the read/write heads against the recording surfaces of the disks 11 and 12. In order to park the read/write heads off the recording surfaces of the disks 11 and 12, a ramp 30 is installed outside the disks 11 and 12, and an end-tab 27 supported by the ramp 30 and extended a predetermined length from a front end portion of the load beam 23 is formed at a front end portion of the load beam 23.

The ramp 30 includes a fixing portion 31 that is fixed to a base member (not shown) of the HDD, and a supporting portion 32 having a supporting surface 33 for supporting the end-tab 27. End portions of the supporting surface 33 toward the disks 11 and 12 are inclined so that loading and unloading of the end-tab 27 can be conducted smoothly.

The ramp 30 includes a flexure limiter 34 to limit the vertical fluctuation of the flexure 24, and an end-tab limiter 37 to limit the vertical fluctuation of the end-tab 27. When an external shock is applied to the HDD, the suspension assembly 22 fluctuates vertically. Here, the flexure limiter 34 and the end-tab limiter 37 respectively limit the vertical fluctuation of the flexure 24 and the end-tab 27 and prevent collision between the sliders 25 facing each other.

However, if the shock applied to the HDD is intense, the load beam 23 and the flexure 24 of the suspension assembly 22 are likely to be bent as illustrated in FIG. 2B, and accordingly, the suspension assembly 22 may deform or the sliders 25 may collide against each other, damaging the read/write head mounted in each of the sliders 25 or generating particles.

### SUMMARY

Example embodiments of the present general inventive concept provide a hard disk drive (HDD) including a slider limiter that prevents collision between sliders or deformation of a suspension assembly due to shocks.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hard disk drive (HDD) including a spindle motor installed to a base member, at least one disk mounted to the spindle motor to be rotated by the spindle motor, an actuator moving a read/write head to a desired position on the at least one disk, wherein the actuator comprises a swing arm that is rotatably mounted to the base member, and a suspension assembly including a load beam coupled to a front end portion of the swing arm, a flexure that is attached to the load beam to support a slider in which the read/write head is mounted, and an end-tab that is extended from a front end portion of the load beam, and a ramp that is installed outside the at least one disk to park the read/write head when the at least one disk stops rotating, wherein a slider limiter that is disposed between the flexures facing each other in order to limit vertical fluctuation of the slider, is formed on the ramp, wherein a step portion is formed concavely in a portion of the slider limiter facing the slider.

The ramp may further include a fixing portion fixedly mounted to the base member, a supporting portion having a supporting surface for supporting the end-tab, and a flexure limiter limiting vertical fluctuation of the flexure, wherein the slider limiter protrudes from the flexure limiter.

The ramp may further include an end-tab limiter that protrudes from the fixing portion such that the end-tab limiter face the supporting surface of the supporting portion, and limits vertical fluctuation of the end-tab.

A width of the step portion of the slider limiter may be larger than a width of the slider.

A buffer member may be attached to a surface of the step portion of the slider limiter.

According The foregoing and/or other features and utilities of the present general inventive concept may also be achieved by providing a hard disk drive (HDD) including a spindle motor installed to a base member, at least one disk mounted to the spindle motor to be rotated by the spindle motor, an actuator moving a read/write head to a position on the at least one disk, wherein the actuator comprises a swing arm that is rotatably mounted to the base member, and a suspension assembly including a load beam coupled to a front end portion of the swing arm, a flexure that is attached to the load beam to support a slider in which the read/write head is mounted, and an end-tab that is extended from a front end portion of the load beam, and a ramp that is installed outside the at least one disk to park the read/write head when the at least one disk stops rotating, wherein a slider limiter that is disposed between the flexures facing each other in order to limit vertical fluctuation of the slider, is formed on the ramp, wherein a hollow space is formed in a portion of the slider limiter facing the slider, and a side-tab is protruded from both sides of the flexure to face the slider limiter on both sides of the hollow space.

The ramp may further include a fixing portion that is fixedly mounted to the base member, a supporting portion having a supporting surface supporting the end-tab, and a flexure limiter limiting vertical fluctuation of the flexure, wherein the slider limiter protrudes from the flexure limiter.

The ramp may further include an end-tab limiter that protrudes from the fixing portion such that the end-tab limiter face the supporting surface of the supporting portion, and limits vertical fluctuation of the end-tab.

A width of the hollow space of the slider limiter may be larger than a width of the slider.

According The foregoing and/or other features and utilities of the present general inventive concept may also be achieved by providing a hard disk drive including a disk to store data and rotated by a spindle motor, a read/write head on the disk to read and write data, an actuator to move the read/write head to a desired position on the disk, the actuator including a swing arm having a load beam coupled to a front end portion of the swing arm, a flexure that is attached to the load beam to support a slider upon which the read/write head is mounted, and an end-tab that is extended from a front end portion of the load beam, and a ramp to park the read/write head when the disk stops rotating, the ramp including a slider limiter that is disposed between the flexures facing each other in order to limit vertical fluctuation of the slider, wherein a step portion is formed in a portion of the slider limiter facing the slider.

The ramp may further include a flexure limiter that limits vertical fluctuation of the flexure, wherein the slider limiter protrudes from the flexure limiter.

The ramp may further include an end-tab limiter that limits vertical fluctuation of the end-tab.

A width of the step portion of the slider limiter may be larger than a width of the slider.

A buffer member may be attached to a surface of the step portion of the slider limiter.

According The foregoing and/or other features and utilities of the present general inventive concept may also be achieved by providing a hard disk drive including a disk to store data and rotated by a spindle motor, a read/write head on the disk to read and write data, an actuator to move the read/write head to a desired position on the disk, the actuator including a swing arm having a load beam coupled to a front end portion of the swing arm, a flexure that is attached to the load beam to support a slider upon which the read/write head is mounted, a side-tab that protrude from a side of the flexure to face the slider limiter on both sides of the hollow space, and an end-tab that is extended from a front end portion of the load beam, and a ramp to park the read/write head when the disk stops rotating, the ramp including a slider limiter that is disposed between the flexures facing each other in order to limit vertical fluctuation of the slider, wherein a hollow space is formed in a portion of the slider limiter facing the slider, and the side-tab faces the slider limiter on a side of the hollow space in order to limit horizontal fluctuation of the slider.

The ramp may further include a flexure limiter that limits vertical fluctuation of the flexure, wherein the slider limiter protrudes from the flexure limiter.

The ramp may further include an end-tab limiter that limits vertical fluctuation of the end-tab.

A width of the hollow space of the slider limiter may be larger than a width of the slider.

A buffer member may be attached to a surface of the step portion of the slider limiter.

### BRIEF DESCRIPTION OF THE DRAWINGS

These and/or other features and advantages of the present general inventive concept will become apparent and more readily appreciated from the following description of the embodiments, taken in conjunction with the accompanying drawings in which:

FIG. 1 is a perspective view illustrating a conventional head parking ramp;

FIGS. 2A and 2B are side views illustrating a read/write head being parked on the conventional head parking ramp illustrated in FIG. 1;

FIG. 3 is a plan view illustrating a hard disk drive (HDD) including a slider limiter, according to an exemplary embodiment of the present general inventive concept;

FIG. 4 is a perspective view illustrating the slider limiter included on a ramp for parking a read/write head, according to an exemplary embodiment of the present general inventive concept;

FIG. 5 is a side view illustrating the ramp and a suspension assembly illustrated in FIG. 4;

FIG. 6 is a perspective view illustrating a buffer member attached to a surface of a step portion of the slider limiter illustrated in FIG. 4; and

FIG. 7 is a perspective view illustrating slider limiters included in the ramp and side-tabs included in the suspension assembly, according to an exemplary embodiment of the present general inventive concept.

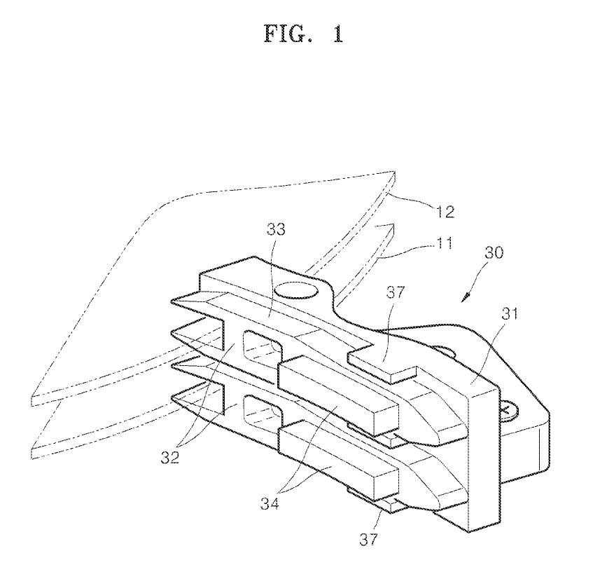

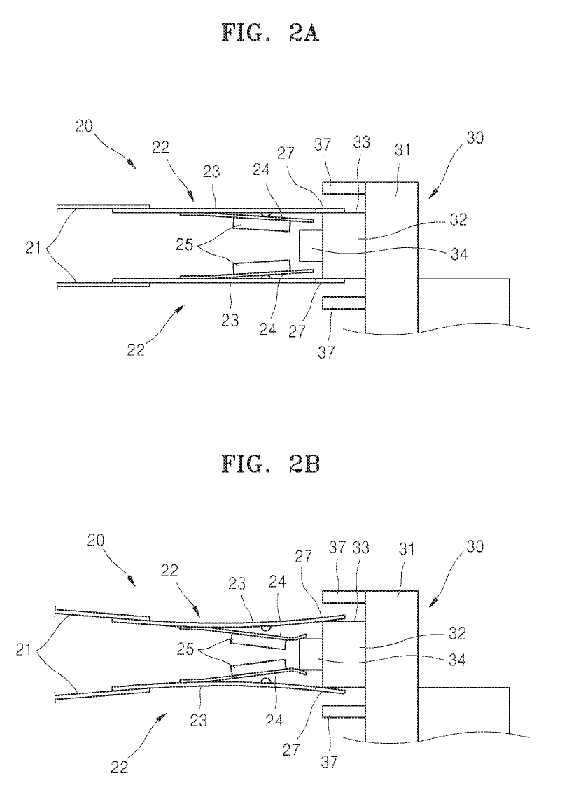

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A hard disk drive (HDD) including a slider limiter, according to exemplary embodiments of the present general inventive concept, will now be described with reference to attached drawings. Like reference numerals in the drawings denote like elements.

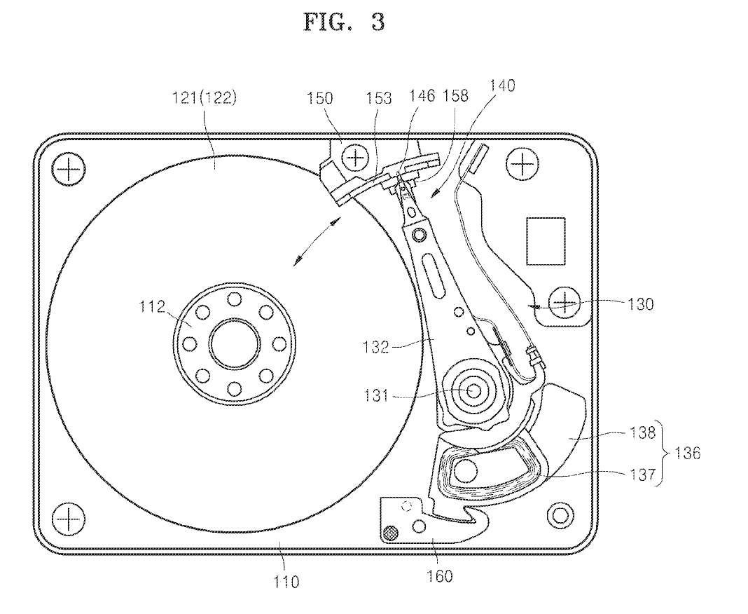

FIG. 3 is a plan view illustrating a hard disk drive (HDD) including a slider limiter 158, according to an exemplary embodiment of the present general inventive concept. Referring to FIG. 3, the HDD includes a spindle motor 112 mounted to a base member 110, at least one disk, here two disks 121 and 122 that are mounted to the spindle motor 112 to be rotated, an actuator 130 for moving a read/write head for writing or reading data from or to a predetermined position of the disks 121 and 122, and a ramp 150 for parking the read/write head when the disks 121 and 122 stop rotating.

The actuator 130 includes a swing arm 132 that is rotatably coupled to an actuator pivot 131 installed on the base member 110, a suspension assembly 140 that is installed on a front end portion of the swing arm 132 to support a slider 145, to which the read/write head is mounted, so that the slider 145 is elastically biased toward a surface of the disk 121 or 122, and a voice coil motor (VCM) 136 rotating the swing arm 132.

The VCM 136 includes a VCM coil 137 coupled to a rear end portion of the swing arm 132, and a magnet 138 that is disposed to face the VCM coil 137. The VCM 136 is controlled by a servo control system, and rotates the swing arm 132 of the actuator 130 in a direction according to Fleming's left hand rule involving the interaction between a current applied to the VCM coil 137 and a magnetic field created by the magnet 138. In detail, when a power source of the HDD is turned on to rotate the disks 121 and 122, the VCM 136 rotates the swing arm 132 in a counter-clockwise direction, moving the read/write head onto the disks 121 and 122. When the power source of the HDD is turned off and the disks 121 and 122 stop rotating, the VCM 136 rotates the swing arm 132 in a clockwise direction so that the read/write head are removed from the recording surfaces of the disks 121 and 122.

The read/write head that has been removed from the recording surfaces of the disks 121 and 122 is parked on the ramp 150 that is disposed outside the disks 121 and 122. In detail, when the disks 121 and 122 stop rotating, the swing arm 132 rotates in a clockwise direction due to the VCM 136, and accordingly, an end-tab 146 disposed in the suspension assembly 140 contacts a supporting surface 153 of the ramp 150, parking the read/write head.

As described above, the read/write head is parked on the ramp 150, and thus, the actuator 130 is locked by using a latch device 160, to prevent the actuator 130 from arbitrarily rotating due to external shocks.

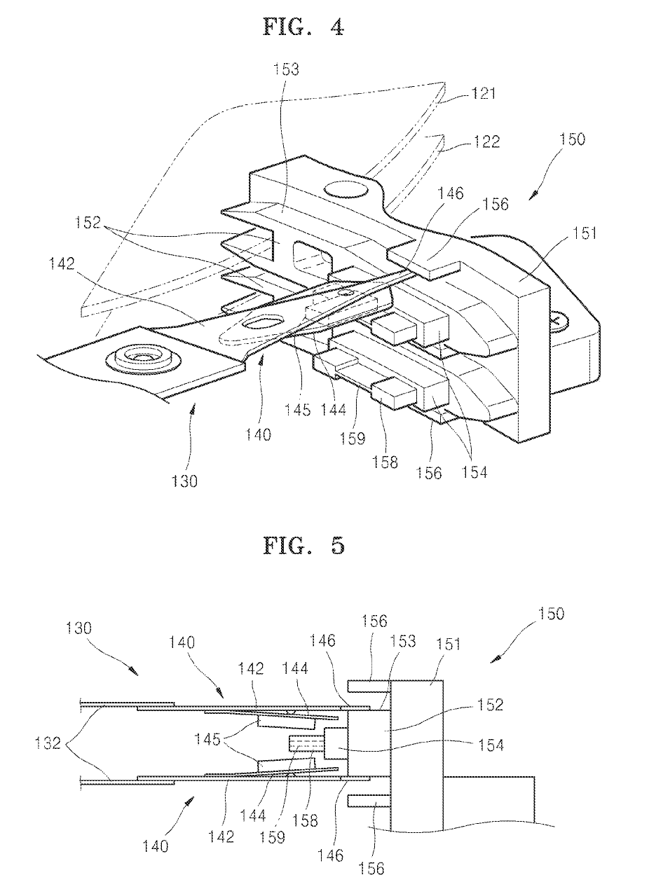

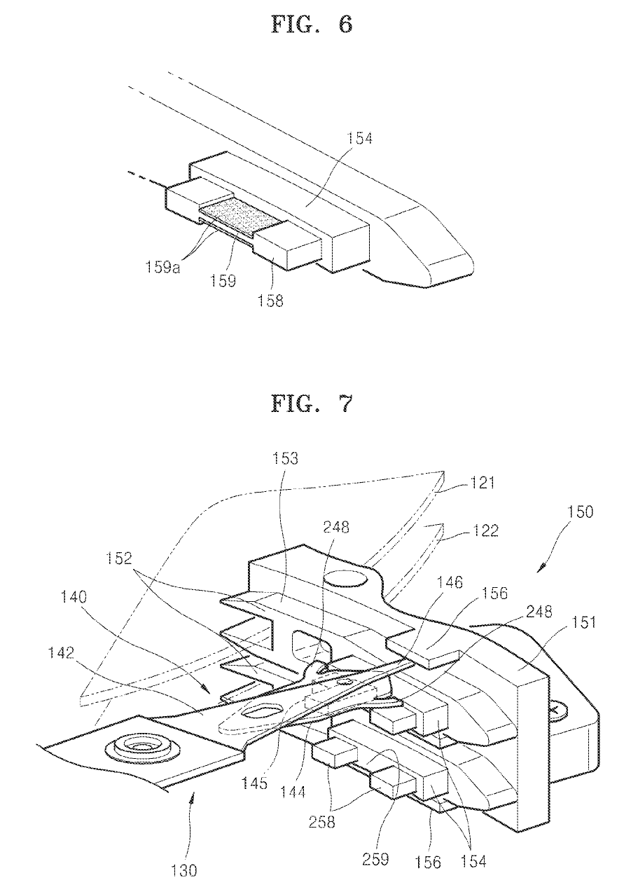

FIG. 4 is a perspective view illustrating the slider limiter 158 included on the ramp 150 for parking a read/write head, according to an exemplary embodiment of the present general inventive concept. FIG. 5 is a side view illustrating the ramp 150 and the suspension assembly 140 illustrated in FIG. 4. FIG. 6 is a perspective view illustrating a buffer member 159a attached to a surface of a step portion 159 of the slider limiter 158 illustrated in FIG. 4.

The slider limiter 158 provides support for the end-tab 146 and limits the vertical fluctuation of the suspension assembly 140. In addition, since the bending of the suspension assembly 140 is also limited by the slider limiter 158, deformation of the suspension assembly 140 may also be prevented. That is, deformation of the suspension assembly 140 can be prevented through the slider limiter 158 when a strong external shock is applied to the HDD.

Referring to FIGS. 4 and 5, the suspension assembly 140 of the actuator 130 may include a load beam 142 that is coupled to the front end portion of the swing arm 132, a flexure 144 that is attached to the load beam 142 to support the slider 145 to which a read/write head is mounted, and the end-tab 146 that is extended a predetermined length from a front end portion of the load beam 142. In detail, a rear end portion of the flexure 144 is attached to a disk-facing surface of the load beam 142 to be fixed thereto, and a front end portion of the flexure 144 is extended to the front end portion of the load beam 142 to freely move to some extent. The end-tab 146 is used in parking the read/write head on the ramp 150. When the HDD is not in use, the end-tab 146 contacts the supporting surface 153 of the ramp 150 to be supported by the supporting surface 153.

The ramp 150 may include a fixing portion 151 fixed to the base member 110, a supporting portion 152 for supporting the end-tab 146 of the suspension assembly 140, a flexure limiter 154 that limits vertical fluctuation of the flexures 144, and an end-tab limiter 156 that limits vertical fluctuation of the end-tab 146. Also, according to an exemplary embodiment of the present general inventive concept, the ramp 150 includes the slider limiter 158 that limits vertical fluctuation of the slider 145 to which the read/write head is mounted.

In detail, the fixing portion 151 is fixed to the base member 110 of the HDD.

The supporting portion 152 protrudes from the fixing portion 151 toward the actuator 130, and an end portion thereof in a length direction of the supporting portion 152, that is, an end portion thereof overlaps an upper surface and a lower surface of an outer edge portion of the disks 121 and 122. An end portion of the supporting surface 153 over the disks 121 and 122 is inclined so that loading and unloading of the end-tab 146 can be smoothly conducted.

The flexure limiter 154 protrudes from the supporting portion 152 toward the actuator 130 such that an upper surface and a lower surface of the flexure limiter 154 respectively face front end portions of the flexures 144. The flexure limiter 154 limits vertical fluctuation of the flexures 144 when the flexures 144 vertically fluctuate due to external shocks.

The end-tab limiter 156 protrudes from the fixing portion 151 toward the actuator 130 and faces the supporting surface 153 of the supporting portion 152. Accordingly, when parking the read/write head, the end-tab 146 is positioned between the supporting surface 153 of the supporting portion 152 and the end-tab limiter 156, and the vertical fluctuation of the end-tab 146 may be limited by the end-tab limiter 156 if the end-tab 146 vertically fluctuates due to external shocks.

The slider limiter 158 protrudes from the flexure limiter 154 toward the actuator 130. In detail, the slider limiter 158 protrudes horizontally from a front surface of the flexure limiter 154, being positioned between the flexures 144 facing each other, and positioned at predetermined distances from the sliders 145 attached to the flexures 144. The slider limiter 158 may be sized the same width as the sliders 145 or wider than the sliders 145. The slider limiter 158 is preferably wider than the sliders 145 and wider than the suspension assembly 140.

When the suspension assembly 140 and the sliders 145 vertically fluctuate due to external shocks, the vertical fluctuation of the suspension assembly 140 and the sliders 145 may be primarily limited by the end-tab limiter 156 and the flexure limiter 154. If the externals shocks applied to the HDD are relatively strong, the load beam 142 and the flexures 144 of the suspension assembly 140 are bent, and in this case, the slider limiter 158 secondarily limits the vertical fluctuation of the sliders 145, thereby preventing collision between the sliders 145 facing each other. In addition, since the vertical fluctuation of the sliders 145 is limited by the slider limiter 158 and thus the bending of the suspension assembly 140 is also limited, deformation of the suspension assembly 140 may also be prevented. That is, collision between the sliders 145 and deformation of the suspension assembly 140 can be prevented through the slider limiter 158 when a strong external shock is applied to the HDD.

Also, a step portion 159 is formed in a portion of the slider limiter 158 facing the slider 145. The step portion 159 preferably has a larger width than a width of the slider 145. If the shocks applied to the HDD are very large, the slider 145 may intensely contact the slider limiter 158 and thus the read/write head mounted to the slider 145 may be damaged or particles may be generated. However, if the step portions 159 are formed concavely in the slider limiter 158 as described above, a sufficient distance is maintained between the sliders 145 and the slider limiter 158, reducing contact between the sliders 145 and the slider limiter 158 and shocks due to the contact. Thus, damage of the read/write head due to contact of the sliders 145 and the slider limiter 158 and generation of particles may be prevented.

Also, as illustrated in FIG. 6, the buffer member 159a may be attached to a surface of the step portion 159 of the slider limiter 158. The buffer member 159a may be formed from a viscoelastic material such as rubber. In this case, when the sliders 145 and the slider limiter 158 contact each other, the shocks are absorbed by the buffer member 159a and generation of particles may be reduced.

FIG. 7 is a perspective view illustrating slider limiters 258 included in the ramp 150 and side-tabs 248 included in the suspension assembly 140, according to an exemplary embodiment of the present general inventive concept.

Referring to FIG. 7, the slider limiters 258 protrude from the flexure limiter 154 of the ramp 150. In detail, the slider limiters 258 horizontally protrude from the front surface of the flexure limiter 154 and are positioned between flexures 144 that face each other. A hollow space 259 is formed approximately in a center portion between the slider limiters 258 facing the sliders 145. The hollow space 259 has a larger width than the width of the sliders 145.

Also, the side-tabs 248 protrude from both sides of the flexures 144 of the suspension assembly 140, and the side-tabs 248 face the slider limiters 258 that are disposed on both sides of the space 259.

As described above, as the space 259 is formed between the slider limiters 258, direct contact between the sliders 145 and the slider limiters 258 is prevented even when the sliders 145 vertically fluctuate greatly due to intense shocks. Accordingly, damage of the read/write head and generation of particles due to contact between the sliders 145 and the slider limiters 258 can be prevented.

When very intense shocks are applied to the HDD, the side-tabs 248 disposed on the flexures 144 of the suspension assembly 140 contact the slider limiters 258, and thus vertical fluctuation of the flexures 144 and the sliders 145 attached to the flexures 144 can be limited. Accordingly, collision between the sliders 145 facing each other does not occur, and deformation of the suspension assembly 140 can be prevented because the suspension assembly 140 is not bent intensely.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A hard disk drive (HDD) comprising:
a spindle motor installed to a base member;
at least one disk mounted to the spindle motor to be rotated by the spindle motor;
an actuator moving a read/write head to a desired position on the at least one disk, wherein the actuator comprises a swing arm that is rotatably mounted to the base member, and a suspension assembly including a load beam coupled to a front end portion of the swing arm, a flexure that is attached to the load beam to support a slider in which the read/write head is mounted, and an end-tab that is extended from a front end portion of the load beam; and
a ramp that is installed outside the at least one disk to park the read/write head when the at least one disk stops rotating,
wherein a slider limiter that is disposed between the flexures facing each other in order to limit vertical fluctuation of the slider, is formed on the ramp, wherein a step portion is formed concavely in a portion of the slider limiter facing the slider.

2. The HDD of claim 1, wherein the ramp further comprises a fixing portion fixedly mounted to the base member, a supporting portion having a supporting surface for supporting the end-tab, and a flexure limiter limiting vertical fluctuation of the flexure,
wherein the slider limiter protrudes from the flexure limiter.

3. The HDD of claim 2, wherein the ramp further comprises an end-tab limiter that protrudes from the fixing portion such that the end-tab limiter face the supporting surface of the supporting portion, and limits vertical fluctuation of the end-tab.

4. The HDD of claim 1, wherein a width of the step portion of the slider limiter is larger than a width of the slider.

5. The HDD of claim 1, wherein a buffer member is attached to a surface of the step portion of the slider limiter.

6. A hard disk drive (HDD) comprising:
a spindle motor installed to a base member;
at least one disk mounted to the spindle motor to be rotated by the spindle motor;
an actuator moving a read/write head to a position on the at least one disk, wherein the actuator comprises a swing arm that is rotatably mounted to the base member, and a suspension assembly including a load beam coupled to a front end portion of the swing arm, a flexure that is attached to the load beam to support a slider in which the read/write head is mounted, and an end-tab that is extended from a front end portion of the load beam; and
a ramp that is installed outside the at least one disk to park the read/write head when the at least one disk stops rotating,
wherein a slider limiter that is disposed between the flexures facing each other in order to limit vertical fluctuation of the slider, is formed on the ramp, wherein a hollow space is formed in a portion of the slider limiter facing the slider, and
a side-tab protrudes from both sides of the flexure to face the slider limiter on both sides of the hollow space.

7. The HDD of claim 6, wherein the ramp further comprises a fixing portion that is fixedly mounted to the base member, a supporting portion having a supporting surface supporting the end-tab, and a flexure limiter limiting vertical fluctuation of the flexure,
wherein the slider limiter protrudes from the flexure limiter.

8. The HDD of claim 7, wherein the ramp further comprises an end-tab limiter that protrudes from the fixing portion such that the end-tab limiter face the supporting surface of the supporting portion, and limits vertical fluctuation of the end-tab.

9. The HDD of claim 6, wherein a width of the hollow space of the slider limiter is larger than a width of the slider.

10. A hard disk drive comprising:
a disk to store data and rotated by a spindle motor;
a read/write head on the disk to read and write data;
an actuator to move the read/write head to a desired position on the disk, the actuator including a swing arm having a load beam coupled to a front end portion of the swing arm, a flexure that is attached to the load beam to support a slider upon which the read/write head is mounted, and an end-tab that is extended from a front end portion of the load beam; and
a ramp to park the read/write head when the disk stops rotating, the ramp including a slider limiter that is disposed between the flexures facing each other in order to limit vertical fluctuation of the slider,
wherein a step portion is formed in a portion of the slider limiter facing the slider.

11. The hard disk drive of claim 10, wherein the ramp further comprises a flexure limiter that limits vertical fluctuation of the flexure,
wherein the slider limiter protrudes from the flexure limiter.

12. The hard disk drive of claim 10, wherein the ramp further comprises an end-tab limiter that limits vertical fluctuation of the end-tab.

13. The hard disk drive of claim 10, wherein a width of the step portion of the slider limiter is larger than a width of the slider.

14. The hard disk drive of claim 10, wherein a buffer member is attached to a surface of the step portion of the slider limiter.

15. A hard disk drive comprising:
a disk to store data and rotated by a spindle motor;
a read/write head on the disk to read and write data;
an actuator to move the read/write head to a desired position on the disk, the actuator including a swing arm having a load beam coupled to a front end portion of the swing arm, a flexure that is attached to the load beam to support a slider upon which the read/write head is mounted, a side-tab that protrude from a side of the flexure to face the slider limiter on both sides of the hollow space, and an end-tab that is extended from a front end portion of the load beam; and
a ramp to park the read/write head when the disk stops rotating, the ramp including a slider limiter that is disposed between the flexures facing each other in order to limit vertical fluctuation of the slider,
wherein a hollow space is formed in a portion of the slider limiter facing the slider, and the side-tab faces the slider limiter on a side of the hollow space in order to limit horizontal fluctuation of the slider.

16. The hard disk drive of claim 15, wherein the ramp further comprises a flexure limiter that limits vertical fluctuation of the flexure,
wherein the slider limiter protrudes from the flexure limiter.

17. The hard disk drive of claim 15, wherein the ramp further comprises an end-tab limiter that limits vertical fluctuation of the end-tab.

18. The hard disk drive of claim 15, wherein a width of the hollow space of the slider limiter is larger than a width of the slider.
